(19) United States
(12) Patent Application Publication
(10) Pub. No.: US 2003/0111393 A1
(43) Pub. Date: Jun. 19, 2003

(54) Method for separating material to be separated using centrifugal air separator

(76) Inventors: Horst Thaler, Weisskirchen (AT); Jurgen Roth, Kammern (AT)

Correspondence Address: CHAPMAN AND CUTLER, 111 WEST MONROE STREET, CHICAGO, IL, 60603, US

(21) Appl. No.: 10/258,468

(22) PCT Filed: Apr. 26, 2001
(86) PCT No.: PCT/AT01/00125

(30) Foreign Application Priority Data
Apr. 26, 2000 (AT) A 730/2000

(51) Int. Cl. B07B 7/08

(52) U.S. Cl. 209/138; 209/139.2; 209/714

(57) ABSTRACT

In a method for separating material to be separated using a centrifugal air separator, wherein material to be separated and separating gas are charged into the air separator and coarse material and fine material are discharged separately, the separating gas is fed into the centrifugal air separator under superatmospheric pressure, optionally along with the material to be separated. The air separator is maintained at superatmospheric pressure at least in the region of the separator rotor.

The invention relates to a method for separating material to be separated using a centrifugal air separator, wherein material to be separated and separating gas are charged into the air separator and coarse material and fine material are discharged separately.

Centrifugal-force air separators are, for instance, described in AT 404 681 B. In that known configuration of a centrifugal-force air separator, either one, or a common, inlet for the material to be separated and the separating gas is (each) provided on its periphery, the housing comprising on its lower side an outlet for coarse material and on its end side a central or non-central outlet for fine material. In the interior of the housing, a separator rotor is mounted, which is actuated by a rotary drive. Besides such a mode of construction, centrifugal-force air separators are known, in which the axis of rotation of the rotor is arranged in a substantially horizontal manner. Centrifugal-force air separators of this type, as a rule, are operated in a manner that an accordingly dimensioned aspirator is connected to the fine-material discharge. By sucking the separating gas off the air separator, a more or less large underpressure is usually generated in the interior of the separator.

The basic principles for assessing the separation qualities of different separator designs are, for instance, described in “Aufbereitungs-Technik”, Vol. 21, 1980, No. 1, pp. 15 to 22, “Neue Hochleistungs-Windsichter für Feinheiten von d_{T97}=3,8 bis 300 Mikron und hohe Durchsatzmengen”. That article deals with spiral separators, bucket-wheel separators and cross-flow separators and, in particular in the context of centrifugal-force separators, points out that for the Stokes range in spiral air separators the degree of fineness and the flow rate are considerably increased by operation at an elevated tangential component. The high-performance separator concretely described is operated at an underpressure of 3300 mm WS, whereby in the event of limestone at a particle size limit d_{T97}=3.8 microns less than 1/10 of the fine material was obtained than with a particle size limit d_{T97}=6 microns. Overall, a higher number of revolutions of the separator rotor and an elevated negative pressure are described to improve the output, it being held that the thus attained higher speed is to ensure a substantially finer separation in the separating chamber.

The invention now aims to further reduce the particle size limit at otherwise equal operating conditions and, in particular, without changing the rotor speed. To solve this object, the method according to the invention essentially consists in that the separating gas is fed into the centrifugal air separator under superatmospheric pressure, optionally along with the material to be separated, and that the air separator is maintained at superatmospheric pressure at least in the region of the separator rotor. Surprisingly, and contrary to previous proposals aimed at improving the separation effect and lowering the maximum fineness attainable, it turned out that the maximum fineness attainable could be substantially lowered merely by increasing the pressure to superatmospheric pressure while preserving the separator speed, gas amount and charging material; thus d_{T97}, for instance, for calcium carbonate could be lowered to 2 μm and below. This unexpected result which has enabled a substantial lowering of the particle size limit, follows a new approach in applying the general law regulating separation processes more or less exactly, which is described below:

Considering the general law that separation processes comply with more or less exactly, this is made up of the force equilibrium between the rejecting centrifugal force F_{Z} and the dragging radial force F_{T}.

The centrifugal force results from the rejection action of the rotor and essentially is a function of its circumferential speed (˜rotational speed) and diameter (radius) as well as the particle mass (˜particle diameter).

$${F}_{Z} = m \cdot \frac{{v}_{u}^{2}}{{r}_{rotor}} = \frac{{d}^{3} \cdot π}{6} \cdot ρ \cdot \frac{{v}_{u}^{2}}{{r}_{rotor}}$$

FZ . . . centrifugal force (N)

m . . . particle mass (kg)

d . . . particle diameter (m)

rᵣₒₜₒᵣ . . . rotor radius (m)

vᵤ . . . circumferential speed (m/s)

The dragging force of the gas flow exerted on the particles depends substantially on the flow speed (in the instant case, the radial speed by the free rotor surfaces vᵣ), the dynamic viscosity of the medium as well as, again, the particle size, it being anticipated that laminar flow conditions prevail around the particle itself at particle sizes of <20 μm. The dragging force can, therefore, be specified according to Stoke (laminar flow)

F_{WI}=3π·η_{dyn}·d·vᵣ

F_{WI} . . . flow resistance (N)

η_{dyn} . . . dynamic viscosity (Pa·s)

Vr . . . radial speed (m/s)

For the socalled limit particle having the diameter d_{T} (particle size limit), it can be anticipated that the two forces are actually in equilibrium. By equating the two relations, d_{T} is calculated as follows:

$${d}_{T} = \sqrt{\frac{18 \cdot {η}_{dyn} \cdot r \cdot {v}_{r}}{ρ \cdot {v}_{u}^{2}}}$$

In addition to the required circumferential speed of the rejection wheel (rotor), also the necessary gas amount and the gas properties (air, vapor, industrial gases, etc.) have great influence on the above-mentioned criteria.

If the amount of gas is increased, this will result, on the one hand, in an improved solids dispersion and hence an improved efficiency, i.e., increase in the output of valuable substances.

On the other hand, an increase in the amount of gas will, however, lead to an increase in the radial speed by the rotor of the separator, and hence an increase in the dragging force, which causes a particle to reach the fine material flow. This brings about an increase in the particle size limiz d_{T} and hence a deterioration of the separating effect, i.e., an increase in the portion of oversized particles contained in the fine material.

Hence follows that, in the main, the particle size limit can be lowered without increasing the amount of gas by merely raising the pressure, whereby, in the context of the method according to the invention, it is preferably proceeded in a manner that the separating gas and the material to be separated are charged via a blower or a condenser or compressor, in particular a rotary piston compressor. Apart from a rotary piston compressor, also a lateral channel condenser, compressor or simply a high-performance fan can be employed.

Depending on the type of the centrifugal-force air separator and, in particular, on the axial length of the separator rotor, a pressure drop within the separation chamber will have to be taken into account. The method according to the invention, therefore, is advantageously realized in a manner that the overpressure relative to the atmospheric pressure is chosen to be larger than the pressure loss determined over the axial length of the rotor, whereby it is ensured that the desired overpressure is available over the total axial length of the rotor.

In the context of the invention, it is advantageously proceeded in a manner that the operating pressure of the centrifugal air separator is chosen between 1.2 and 5 bars at least in the region of the separator rotor, wherein air, vapor and/or industrial gases such as, e.g., combustion offgases are used as separating gas in a particularly advantageous manner.

In the context of the method according to the invention, conventional centrifugal separators which are designed for defined operating parameters such as, for instance, the speed of the rotor, and its dimension can be readily adapted to the desired particle size limit, to which end it is advantageously proceeded in a manner that the overpressure of the blower is controlled as a function of the particle size limit determined. It is, thus, feasible to reduce the particle size limit accordingly by particularly simple measures, i.e., merely by increasing the pressure and using a compressing fan instead of the usually employed suction without carrying out any modification at the existing centrifugal air separators.

1. A method for separating material to be separated using a centrifugal air separator, wherein material to be separated and separating gas are charged into the air separator and coarse material and fine material are discharged separately, characterized in that the separating gas is fed into the centrifugal air separator under superatmospheric pressure, optionally along with the material to be separated, and that the air separator is maintained at superatmospheric pressure at least in the region of the separator rotor, wherein the overpressure relative to the atmospheric pressure is chosen to be larger than the pressure loss determined over the axial length of the rotor.

2. A method according to claim 1, characterized in that the separating gas and the material to be separated are charged via a blower or a compressor, in particular a rotary compressor.

3. A method according to claim 1 or 2, characterized in that the operating pressure of the centrifugal air separator is chosen between 1.2 and 5 bars at least in the region of the separator rotor.

4. A method according to any one of claims 1 to 3, characterized in that air, vapor and/or industrial gases such as, e.g., combustion offgases are used as separating gas.

5. A method according to any one of claims 1 to 4, characterized in that the overpressure of the blower is controlled as a function of the particle size limit determined.
